(19) United States
(12) Patent Application Publication
(10) Pub. No.: US 2020/0122682 A1
(43) Pub. Date: Apr. 23, 2020

(54) LOCKING DEVICE, IN PARTICULAR, FOR A MOTOR VEHICLE

(71) Applicant: Marquardt GmbH, Rietheim-Weilheim (DE)

(72) Inventors: Ali KAPLAN, Rietheim-Weilheim (DE); Midhun PARAPPUR KIZHUVEETUVALAPPIL, Malappuram (IN)

(73) Assignee: Marquardt GmbH, Rietheim-Weilheim (DE)

(21) Appl. No.: 16/669,926

(22) Filed: Oct. 31, 2019

Related U.S. Application Data
(63) Continuation of application No. PCT/EP2018/061798, filed on May 8, 2018.

(30) Foreign Application Priority Data
May 11, 2017 (DE) 10 2017 004 505.4

(51) Int. Cl. B60R 25/0215

(52) U.S. Cl. CPC B60R 25/0215

(57) ABSTRACT

A locking device including a blocking member movable between first and second positions for locking a component. In the first position, the blocking member (i) engages the component in a blocking manner and/or (ii) is brought into engagement with the component in a blocking manner. In the second position, the blocking member is not in engagement with the component. A drive element moves the blocking member between the two positions. The locking device also includes a securing mechanism for the blocking member that cooperates with the blocking member in the first position in the manner of a back pressure securing element for the blocking member for preventing manipulation, and also cooperates with the blocking member in the second position in the manner of a securing device for securing the blocking member in the second position against unintended movement into the first position.

### CROSS REFERENCE TO RELATED APPLICATIONS

This application is a continuation of International Application No. PCT/EP2018/061798 filed May 8, 2018, which designated the United States, and claims the benefit under 35 USC § 119(a)-(d) of German Application No. 10 2017 004 505.4 filed May 11, 2017, the entireties of which are incorporated herein by reference.

### FIELD OF THE INVENTION

The present invention relates to a locking device, in particular, for a motor vehicle.

### BACKGROUND OF THE INVENTION

Such locking devices serve as a steering lock for locking the steering column in a motor vehicle, more specifically, the steering shaft for the steering wheel in order to increase the theft protection. For example, the locking devices are locked and/or unlocked when the ignition lock is actuated and/or when activated by a control device in the motor vehicle. Instead of the steering column, any other functionally relevant component of the motor vehicle, for example, the gear lever or the like, may also be lockable.

In motor vehicles, an electronic ignition lock which is actuatable by an electronic key may be used instead of a mechanical ignition lock. Reference is made to DE 44 34 587 A1 for a more detailed description of such an electronic ignition lock. Moreover, drive authorization systems with a “KeylessGo” functionality may also be used in motor vehicles, in which the authentication of the electronic key is carried out automatically by a code being transmitted by electromagnetic waves when the user is located inside the motor vehicle and, for example, actuates a start/stop button in the dashboard.

In the case of an electronic ignition lock and/or a drive authentication system with KeylessGo functionality, advantageously the steering lock may be driven by a drive, for example, an electric motor. The electric motor is only activated for unlocking when the coded data of the electronic key are correct, i.e. when the key belonging to the motor vehicle is identified. Such a steering lock is a so-called electric and/or electronic steering lock.

Such a locking device comprises a blocking member which is movable between a first position and a second position for locking the functionally relevant component. In the first position, the blocking member is in engagement with the component in a blocking manner and/or in the first position the blocking member can be brought into engagement with the component in a blocking manner. In the second position, the blocking member is not in engagement with the component. A drive element serves for moving the blocking member between the two positions. Moreover, the previously disclosed locking device comprises two securing mechanisms for the blocking member, acting in each case in one of the two positions. The design of the locking device is complex.

### SUMMARY OF THE INVENTION

The object of the present invention is to develop the locking device with regard to the securing mechanism. In particular, the securing mechanism is intended to be designed in a simple manner and/or require a small amount of constructional space in the locking device.

In the locking device according to the present invention, the securing mechanism is designed to cooperate with the blocking member in the first position and also to cooperate with the blocking member in the second position. In particular, the securing mechanism serves and/or acts in the manner of a back pressure securing element for the blocking member in the first position for preventing manipulation and in the manner of a securing device for securing the blocking member in the second position against the unintended movement thereof into the first position. Thus, it may be observed that advantageously the one securing mechanism controls two functionalities so that the present invention achieves a significant simplification of the locking device and/or a reduction in the constructional space for the locking device.

A housing may be provided for protecting the locking device from external influences. Expediently, the housing may comprise a base, wherein the blocking member may be movably guided in the base. For the purpose of protecting from manipulation, in particular, with regard to theft protection, the base may consist of metal. Similarly, it may be provided that for the sake of good resistance the blocking member consists of metal.

In a manner which is functionally reliable, the drive element may be configured in the manner of a wormgear. Moreover, it may be provided that a lifting curve is located on the drive element. In this case, the blocking member may engage by a pin in the lifting curve, such that when the drive element is driven the blocking member is movable between the two positions. In a simple embodiment, an electric motor may be provided for driving the drive element, in particular, for the rotation thereof. The electric motor may be a DC motor.

In a compact embodiment, two receivers may be provided in the blocking member for the cooperation of the securing mechanism with the blocking member. In particular, in each case, one receiver is provided for latching the securing mechanism in the respective position such that the movement of the blocking member is blocked in the respective position by the securing mechanism. In a simple manner, the securing mechanism may be configured in the manner of a slider. Moreover, the securing mechanism may be loaded by a force acting in the direction of the receiver, by a resilient element, in particular, by a spring. In a compact embodiment, the securing mechanism may be movably arranged in a guide in the base. For the purpose of a high level of resistance against manipulation, the securing mechanism may consist of metal.

In a simple and compact embodiment, a sliding block guide may be provided on the drive element for the movement of the securing mechanism out of the receiver counter to the spring force effected by the resilient element and/or for the release of the movement of the securing mechanism into the receiver by the force effected by the resilient mechanism. In a compact and functionally reliable manner, the drive element may be configured to be approximately cylindrical with a first cover surface, a second cover surface and an outer surface located between the two cover surfaces. In this case, the lifting curve may be located on the outer surface. Moreover, the sliding block guide may be located on the second cover surface. The securing mechanism may in turn engage in the sliding block guide by means of a cam.

Finally, a signal generating mechanism cooperating with the drive element may be provided for the respective position of the blocking member, so that the position which is respectively adopted by the blocking member may be detected. In a manner which is functionally reliable but simple, the signal generating mechanism may consist of a magnet and a Hall sensor. The magnet may in turn be arranged in a compact manner in and/or on the drive element.

For a particularly preferred embodiment of the locking device according to the present invention, the following may be observed.

The previously disclosed locking devices provide in each case separate concepts for the back pressure securing element of the blocking member and for securing the blocking member. These concepts have a complex mechanism which additionally requires a large amount of constructional space. Thus, the complexity is intended to be simplified and the effectiveness increased by the concept according to the present invention and/or the costs for the locking device are intended to be reduced. To this end, the present invention proposes combining the back pressure securing element and the blocking member securing element by a slider which is moved by an eccentric, instead of individual concepts for the separate functionalities. The slider thus simultaneously effects the two functionalities of safety and theft protection for the locking device, i.e. the slider provides the back pressure securing element corresponding to Thatcham requirements as well as the safety function for the blocking member.

A wormgear driven by a DC (direct current) motor serves for moving the blocking member. An eccentric profile is located on the wormgear for driving the slider in the positions thereof corresponding to the movement of the wormgear.

Two receivers, namely receiver 1 (blocking member locked) and receiver 2 (blocking member unlocked) are provided in the manner of pockets in the blocking member at the point where the slider cooperates with the blocking member in the respective position of the blocking member. The slider is acted upon by a compression spring. If the blocking member moves into the locked position, the receiver 1 is aligned with the axis of the slider and the slider moves by the force of the compression spring into the receiver 1. As a result, the movement of the blocking member into the unlocked position due to manipulation is prevented. This movement is only possible with correct activation of the locking device by rotating the wormgear. Correspondingly, when the blocking member is moved and the blocking member reaches the unlocked position the slider is aligned with the receiver 2. Due to the spring force, the slider then moves forward into the receiver 2. As a result, the rearward movement of the blocking member into the locked position is prevented so that the blocking member is secured against inadvertent movement. Between the two positions of the blocking member, namely the locked position and the unlocked position, the slider is moved away from the blocking member by the eccentric profile in the wormgear, whereby the blocking member is not hindered, even in the case of a malfunction.

By means of the present invention, therefore, a multifunctional concept for the slider in the locking device is provided, and namely for achieving the back pressure securing element and the securing function for the blocking member.

The advantages achieved by the present invention consist, in particular, in that the one securing mechanism simultaneously implements a plurality of functionalities for the locking device. As a result, the locking device is of compact design, requires little constructional space and has a lower weight. Moreover, as a result, a reduction in production costs may be achieved for the locking device.

### BRIEF DESCRIPTION OF THE DRAWINGS

An exemplary embodiment of the present invention with various developments and embodiments is shown in the drawings and is described in more detail hereinafter.

FIG. 1 shows a steering wheel of a motor vehicle with a locking device in a schematic view;

FIG. 2 shows a part of the locking device of FIG. 1 in an exploded view, wherein the locking device has a blocking member, a drive element and a securing mechanism;

FIG. 3 shows the blocking member of FIG. 2 as a separate part;

FIG. 4 shows the drive element of FIG. 2 as a separate part;

FIG. 5 shows the blocking member, the drive element and the securing mechanism of FIG. 2 as separate parts;

FIG. 6 shows the cooperation of the drive element with the blocking member and with the securing mechanism;

FIG. 7 shows the drive element as in FIG. 4 in a further rotated position;

FIG. 8 shows a section through the arrangement of FIG. 6, wherein the blocking member is located in a first position;

FIG. 9 shows a section as in FIG. 8, wherein the blocking member is located between the first and a second position; and

FIG. 10 shows a section as in FIG. 8, wherein the blocking member is located in the second position.

### DETAILED DESCRIPTION OF THE INVENTION

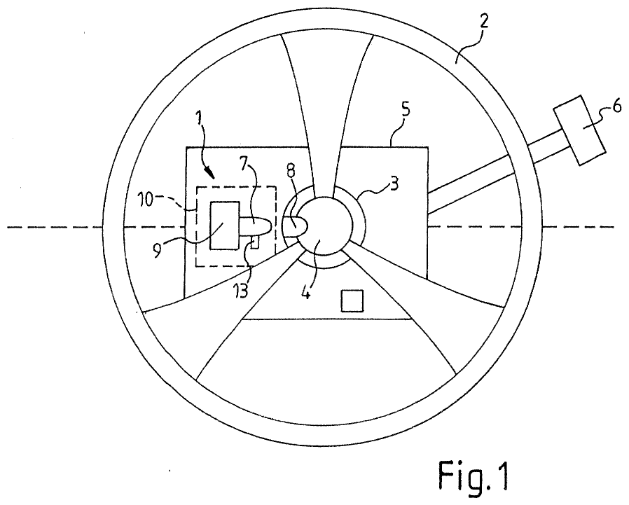

A steering wheel 2 with a steering column 3 for a motor vehicle may be seen in FIG. 1. The steering shaft 4 connected to the steering wheel 2 is located in the steering column 3. In the conventional manner, a support arrangement 5 in the manner of a steering module with a steering column stalk switch 6 is arranged on the steering column 3. In the vicinity of the steering wheel 2, a locking device 1 configured as an electric steering lock is arranged at a suitable point on the steering column 3, wherein the locking device 1 is shown schematically and in a partially broken away view.

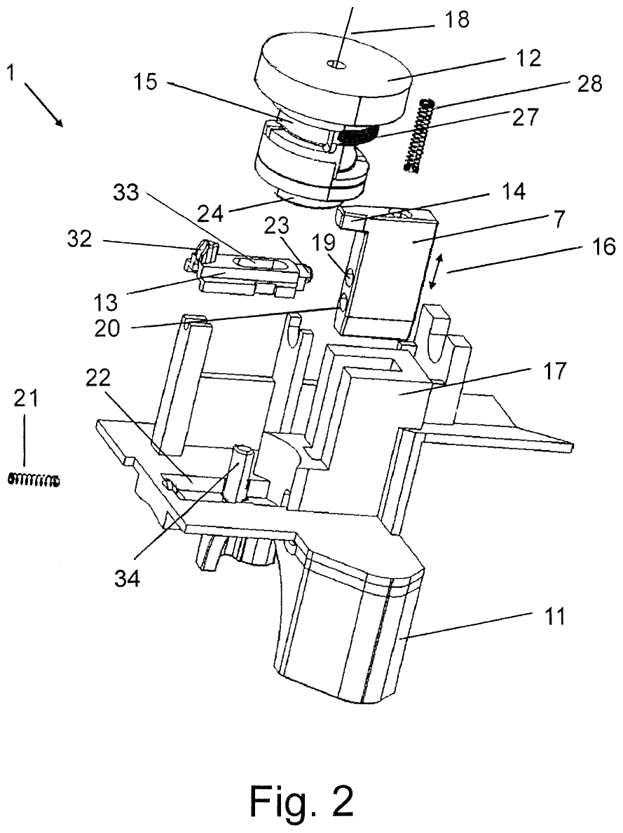

The locking device 1 has a blocking member 7 which is movable between two positions and which is acted upon by the force of a compression spring 28 (see FIG. 2). The blocking member 7 is able to be brought into a latched position 8 on the steering shaft 4 in the steering column 3 corresponding to a first position, so that the blocking member 7 is engaged with the steering shaft 4 in a blocking manner. Thus, the steering wheel 2 is blocked and, therefore, may not be rotated. The blocking member 7 is not engaged in a locking and/or blocking manner relative to the latched position 8 on the steering shaft 4 in a second position, whereby the steering wheel 2 is released for rotation. In FIG. 1 only a latched position 8 is shown, but a plurality of latched positions 8 may also be provided in the manner of a toothed ring on the steering shaft 4 in the steering column 3 for blocking the rotational movement of the steering shaft 4, so that the engagement of the blocking member 7 in a locking manner is possible in various positions of the steering wheel 2. The locking device 1 also has a drive 9 for the movement of the blocking member 7 between the two positions. Finally, a housing 10 is also provided for the locking device 1.

Parts of the electric steering lock 1 are visible in more detail in an exploded view in FIG. 2. The housing 10 comprises a base 11 and a cover, wherein in FIG. 2 the cover is omitted. The base 11 consists of resistant metal, for example, a zinc die casting. The cover may also consist of metal but it is also sufficient if the cover is optionally produced from thermoplastic material by injection-molding. The drive 9 comprises an electric motor, not shown further, and a drive element 12 for moving the blocking member 7, wherein the blocking member 7 is movably guided in a guide attachment 17 in the base 11.

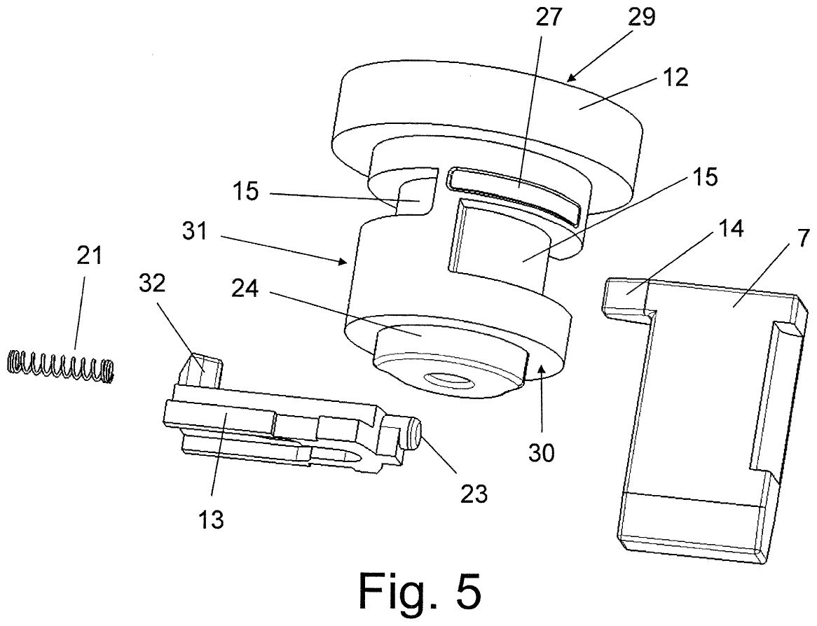

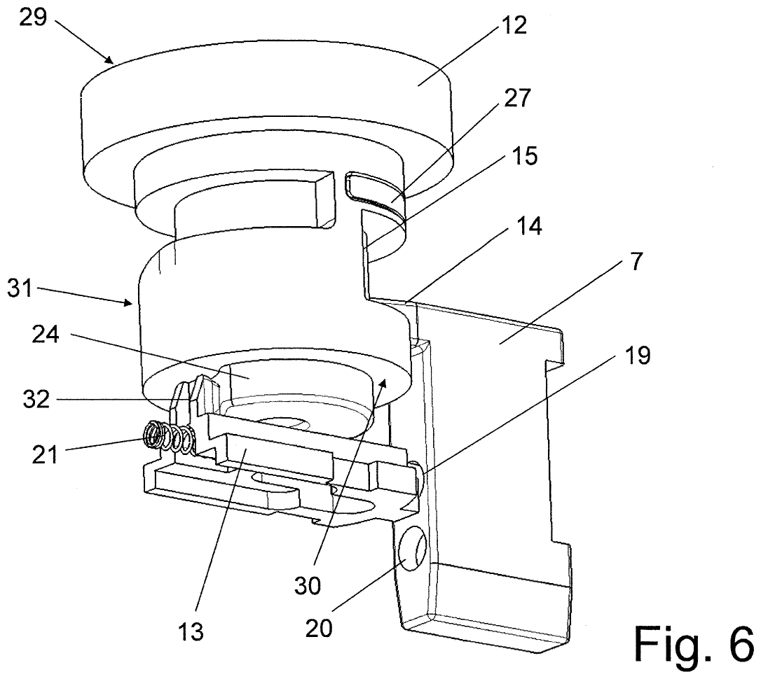

In the present case, the drive element 12 is embodied as a wormgear. Namely, the wormgear 12 is designed to be approximately cylindrical with an upper first cover surface 29 and a lower second cover surface 30 as well as an outer surface 31 located between the two cover surfaces 29, 30, as may be derived in more detail from FIG. 5. The wormgear 12 has on its periphery, for example, on the first cover surface 29, a toothing, not shown further, by which a worm meshes on the output shaft of the electric motor so that the wormgear 12 is rotatable about a rotational axis 18 by means of the electric motor. The blocking member 7 is articulated on the wormgear 12 and namely to this end a pin 14 on the blocking member 7 engages in a lifting curve 15 located on the periphery of the wormgear 12, namely on the outer surface 31, as may be derived further from FIGS. 5 and 6. As a result, corresponding to FIG. 2, by rotating the wormgear 12 by the electric motor in the respective rotational direction, the blocking member 7 which is arranged on the wormgear 12 is movable in a translatory manner in the direction of the rotational axis 18 from the first position into the second position and from the second position into the first position, i.e. between the first position and the second position according to the double arrow 16.

Moreover, a securing mechanism 13 is provided for the blocking member 7. The securing mechanism 13 is configured both for cooperation with the blocking member 7 in the first position and also for cooperation with the blocking member 7 in the second position. Namely, the securing mechanism 13 firstly acts in the manner of a back pressure securing element for the blocking member 7 in the first position, for preventing manipulation, whereby the theft protection is improved. Secondly, the securing mechanism 13 acts in the manner of a securing device for securing the blocking member 7 in the second position against inadvertent movement into the first position due to a malfunction, whereby the safety of the user is improved relative to hazardous situations.

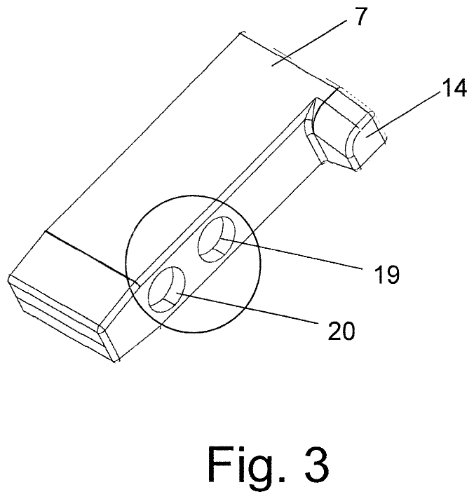

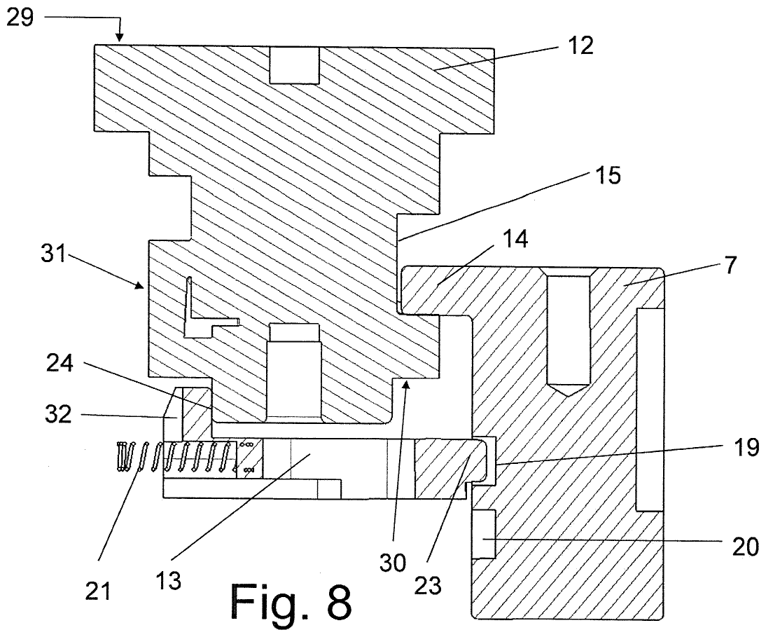

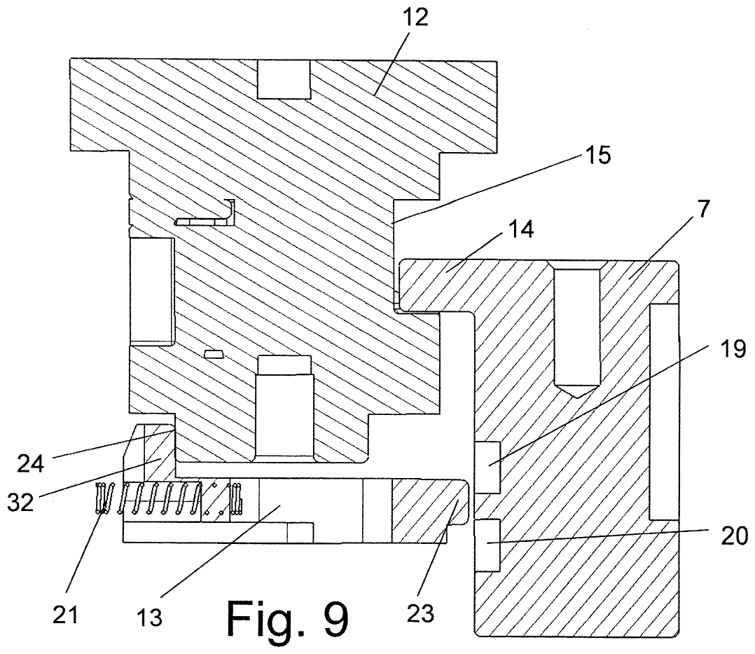

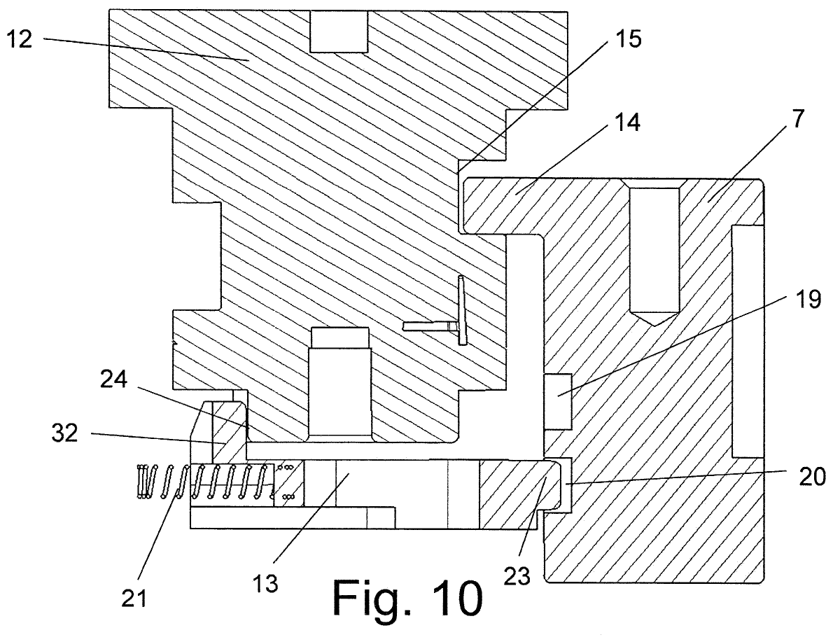

For the cooperation of the securing mechanism 13 with the blocking member 7, two receivers 19, 20 which are visible in FIG. 3 are provided in the blocking member 7. In each case, a receiver 19, 20 is provided for the latching of the securing mechanism 13 in the respective position of the blocking member 7 such that the movement of the blocking member 7 in the respective position is blocked by the securing mechanism 13. As may be seen more clearly in FIG. 8, the securing mechanism 13 engages in a latched manner by a latching pin 23 (see also FIG. 5) in the first receiver 19 on the blocking member 7 when the blocking member 7 is in the first position. As a result, a movement of the blocking member 7 from the first position is prevented, whereby the securing mechanism 13 acts in the manner of a back pressure securing element for the blocking member 7 for the purpose of increasing the theft protection. As shown further in FIG. 10, the securing mechanism 13 engages in a latched manner by the latching pin 23 in the second receiver 20 on the blocking member 7 when the blocking member 7 is located in the second position. As a result, a movement of the blocking member 7 from the second position is prevented, whereby the securing mechanism 13 acts in the manner of a securing device for the blocking member 7 for protecting against malfunctions. As is finally visible in FIG. 9, the securing mechanism 13 is in a retracted position when the blocking member 7 is moved between the first position and the second position, so that the movement of the blocking member 7 is not hindered by the latching pin 23.

As is also visible in FIG. 2, the securing mechanism 13 is configured in the manner of a slider. The securing mechanism 13 is movably arranged in a guide 22 in the base 11. The movement of the securing mechanism 13 in this case is defined by the cooperation of a stop 34 in the base 11 with a slot 33 in the securing mechanism 13. As may be identified with reference to FIG. 6, the securing mechanism 13 is loaded with a force acting in the direction of the receiver 19, 20, by a resilient element 21, for example, by a spring. For the purpose of a high level of operational reliability and/or theft protection, it is provided that the securing mechanism 13 and/or the blocking member 7 consist of metal, for example, of a zinc die casting.

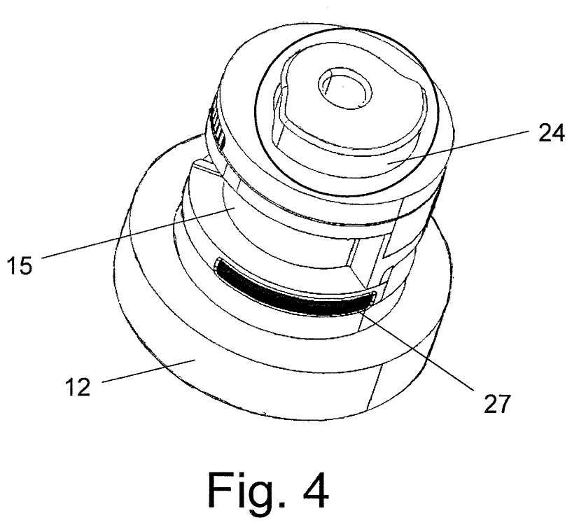

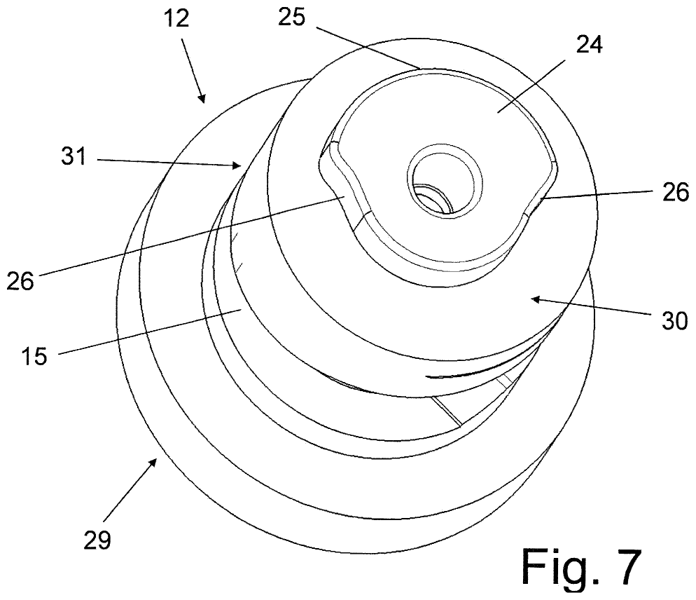

For the movement of the securing mechanism 13, a sliding block guide 24, visible in FIG. 4 or FIG. 7, is provided on the drive element 12 and namely on the second cover surface 30 (see FIG. 5), wherein the securing mechanism 13 engages by a cam 32 in the sliding block guide 24. As may be identified in FIGS. 6 and 9, with a corresponding rotation of the drive element 12, the securing mechanism 13 is movable by the sliding block guide 24 against the spring force effected by the resilient element 21 in the guide 22, so that the latching pin 23 is disengaged from the receiver 19, 20. This movement of the securing mechanism 13 is effected by the eccentrically designed first portion 25 of the sliding block guide 24, which is more clearly visible in FIG. 7. As may be further identified with reference to FIGS. 6, 8 and 10, with a corresponding rotation of the drive element 12, the securing mechanism 13 is released for movement by the sliding block guide 24, so that due to the spring force effected by the resilient element 21, the latching pin 23 is latched in the receiver 19, 20. The second portion 26 of the sliding block guide 24, visible in FIG. 7, serves for releasing the movement of the securing mechanism 12, the second portion having a reduced radius relative to the first portion 25.

For detecting the respective position of the blocking member 7, a signal generating mechanism cooperating with the drive element 12 is provided. The signal generating mechanism consists of a magnet 27 and a Hall sensor, not shown further, correspondingly cooperating with the magnet 27. The magnet 27 is arranged in and/or on the drive element 12, as shown in FIG. 5. Naturally, any other sensor may also be used as the signal generating mechanism, for example, an electric switch.

The present invention is not limited to the exemplary embodiment described and shown. Instead, it also encompasses all developments by the person skilled in the art within the scope of the present invention. Thus such a locking device 1 may not only be used as a steering lock on the steering column but also on any other functionally relevant component and/or control unit of the motor vehicle. Such a component and/or control unit may, for example, be the gear lever, the selector lever for an automatic gearbox, the starter motor, or the like. Moreover, such a locking device 1 may also be used on any other lock, for example, in the case of a door lock for the motor vehicle, for an immovable property, or the like.

### LIST OF REFERENCE NUMERALS

1: Locking device/electric steering lock
2: Steering wheel
3: Steering column
4: Steering shaft
5: Support arrangement
6: Steering column stalk switch
7: Blocking member
8: Latched position
9: Drive
10: Housing (of locking device)
11: Base (of housing)
12: Drive element/wormgear
13: Securing mechanism
14: Pin (on blocking member)
15: Lifting curve (on drive element)
16: Double arrow
17: Guide attachment
18: Rotational axis (of drive element)
19: First receiver (in blocking member)
20: Second receiver (in blocking member)
21: Resilient element (for securing mechanism)
22: Guide (for securing mechanism)
23: Latching pin (on securing mechanism)
24: Sliding block guide (on drive element)
25: First portion (on sliding block guide)
26: Second portion (on sliding block guide)
27: Magnet
28: Compression spring (for blocking member)
29: First cover surface (of drive element)
30: Second cover surface (of drive element)
31: Outer surface (of drive element)
32: Cam (on securing mechanism)
33: Slot (in securing mechanism)
34: Stop

1. A locking device comprising: a blocking member which is movable between a first and a second position for locking a functionally relevant component, wherein in the first position the blocking member is in engagement with the component in a blocking manner and/or in the first position the blocking member can be brought into engagement with the component in a blocking manner, and in the second position the blocking member is not in engagement with the component, said locking device comprising a drive element for moving the blocking member between the two positions and comprising a securing mechanism for the blocking member that is designed to cooperate with the blocking member in the first position and also to cooperate with the blocking member in the second position, wherein the securing mechanism acts in the manner of a back pressure securing element for the blocking member in the first position for preventing manipulation and in the manner of a securing device for securing the blocking member in the second position against unintended movement into the first position.

2. The locking device as claimed in claim 1, further comprising a housing that includes a base, wherein the blocking member is movably guided in the base.

3. The locking device as claimed in claim 1, wherein the drive element is configured in the manner of a wormgear, wherein a lifting curve is located on the drive element, wherein the blocking member engages by a pin in the lifting curve, such that when the drive element is driven the blocking member is movable between the two positions.

4. The locking device as claimed in claim 1, further comprising two receivers in the blocking member for the cooperation of the securing mechanism with the blocking member, wherein in each case a receiver is provided for latching the securing mechanism in the respective position, such that the movement of the blocking member is blocked in the respective position by the securing mechanism.

5. The locking device as claimed in claim 4, wherein the securing mechanism is configured in the manner of a slider and wherein the securing mechanism is loaded by a force acting in the direction of the receiver by a resilient element.

6. The locking device as claimed in claim 2, wherein the securing mechanism is movably arranged in a guide in the base, wherein the securing mechanism consists of metal and wherein the blocking member consists of metal.

7. The locking device as claimed in claim 5, further comprising a sliding block guide on the drive element for the movement of the securing mechanism out of the receiver counter to the force effected by the resilient element and/or for the release of the movement of the securing mechanism into the receiver by the force effected by the resilient element.

8. The locking device as claimed in claim 3, wherein the drive element is designed to be approximately cylindrical with a first cover surface, a second cover surface and an outer surface located between the two cover surfaces, wherein the lifting curve is located on the outer surface, wherein the sliding block guide is located on the second cover surface and wherein even the securing mechanism engages by a cam in the sliding block guide.

9. The locking device as claimed in claim 1, further comprising a signal generating mechanism cooperating with the drive element for the respective position of the blocking member, wherein the signal generating mechanism consists of a magnet and a Hall sensor and wherein the magnet is arranged in and/or on the drive element.

10. The locking device as claimed in claim 1, wherein the locking device is an electric steering lock for a motor vehicle, and wherein the functionally relevant component is a steering shaft in a steering column or a gear lever.

11. The locking device as claimed in claim 2, wherein the base consists of metal.

12. The locking device as claimed in claim 3, further comprising an electric motor for driving the drive element in particular for the rotation thereof.

13. The locking device as claimed in claim 5, wherein the resilient element is a spring.
